(19) United States
(12) Patent Application Publication
(10) Pub. No.: US 2025/0320921 A1
(43) Pub. Date: Oct. 16, 2025

(54) PRIMARY GASKET FOR A CYLINDER ASSEMBLY, CYLINDER ASSEMBLY

(71) Applicant: Brembo S.p.A., Curno, Bergamo (IT)

(72) Inventors: Marco CARRARA, Curno, Bergamo (IT); Luca MAZZEI, Curno, Bergamo (IT); Paolo SALA, Curno, Bergamo (IT)

(21) Appl. No.: 18/865,040

(22) PCT Filed: May 10, 2023
(86) PCT No.: PCT/IB2023/054822

§ 371 Date: Nov. 12, 2024

(30) Foreign Application Priority Data
May 13, 2022 (IT) 102022000009953

(51) Int. Cl. F16J 15/3236; B60T 11/232

(52) U.S. Cl. CPC F16J 15/3236; B60T 11/232

(57) ABSTRACT

The present invention relates to a primary gasket (1) for a cylinder assembly (100), wherein said cylinder assembly (100) comprises a cylinder (101) and a float (102) slidingly accommodated in a float housing (104) delimited by a cylinder wall (103) of said cylinder (101) for pressurizing a fluid, wherein the primary gasket (1) comprises an annular body (2), which extends circumferentially at least along a circumferential direction (C-C) about an axial direction (X-X), wherein said primary gasket (1) defines a radial direction (R-R) perpendicular to said axial direction (X-X) and said circumferential direction (C-C), wherein said annular body (2) is configured to be accommodated in a primary gasket housing (105) defined in said cylinder wall (103), wherein the primary gasket housing (105) is delimited radially by an axial housing wall (107) and axially by a first radial housing wall (108) and a second radial housing wall (109) connected to said axial housing wall (107), wherein said annular body (2) comprises an inner lip (4), a central lip (5), an outer lip (6), and a back portion (3), wherein the back portion (3) comprises a back abutment surface (13) configured to abut against the first radial housing wall (108) of said primary gasket housing (105), wherein the inner lip (4), the central lip (5), and the outer lip (6) extend axially from the back portion (3), on the side opposite to the back abutment surface (13), radially spaced apart from one another, wherein the inner lip (4) is configured to form a seal with said float (102), wherein the outer lip (6) is configured to form a seal with said axial housing wall (107), wherein the central lip (5) comprises an annular lip body (14), which extends axially between said back portion (3) and a central lip edge (15), wherein the annular lip body (14) has a central lip thickness (S) along said radial direction (R-R), wherein the central lip edge (15) comprises at least one central lip abutment portion (7) configured to abut against the second radial wall (109), wherein the central lip (5) comprises at least one radial opening (9), wherein said at least one radial opening (9) passes through the central lip thickness (S) defining a closed side opening profile (8) in said annular body (14).

### FIELD OF THE INVENTION

The present invention relates to a primary gasket for a cylinder assembly, as well as to a cylinder assembly for a hydraulic and/or electrohydraulic system of a vehicle.

### BACKGROUND ART

In the field of cylinder assemblies for hydraulic and/or electrohydraulic systems in a vehicle, such as a brake master cylinders and/or brake actuators, it is known to arrange a sealingly movable float inside a hollow cylinder which defines an axial direction A-A, and a radial direction R-R perpendicular to the axial direction.

The float is axially movable in the hollow cylinder between a resting configuration and at least one advanced configuration to pressurize a fluid, e.g., a brake fluid, in a pressure chamber in the hollow cylinder.

When the float is in a resting configuration, the pressure chamber is in fluid communication with a fluid reservoir by means of a supply conduit. When the float is in a resting configuration, the pressure in the pressure chamber is equal to the pressure of the reservoir. When the float advances axially toward the at least one advanced configuration, the pressure chamber and the reservoir are fluidically isolated, allowing the fluid in the pressure chamber to be pressurized.

The float is axially movable by sliding tightly on a primary gasket and a secondary gasket which are accommodated in respective housings or grooves, a primary housing and a secondary housing, made in the wall of the hollow cylinder. The primary housing and the secondary housing are made in the wall of the hollow cylinder. The supply conduit leads radially from the hollow cylinder wall into a supply opening arranged between the primary housing and the secondary housing.

The secondary gasket is adapted to form a static and dynamic seal between the cylinder and the float to avoid the fluid in the reservoir and/or pressure chamber, when in fluid communication with the reservoir, from flowing into the cylinder in the opposite direction to the pressure chamber. For example, the secondary gasket serves the function of hydraulically isolating the electromechanical components accommodated in the cylinder on the side opposite to the pressure chamber, and/or preventing leakages of hydraulic fluid from the pressure chamber.

The primary gasket is adapted to keep the fluid pressurized in the pressure chamber, preventing fluid passages from the pressure chamber to the reservoir when the float is in an advanced position in the cylinder. In this case, the primary gasket is in a fluid isolation configuration, with a back portion thereof abutting against a first radial wall of primary housing.

If the hydraulic system needs a further pressure increase, at least one valve which increases the pressure in the reservoir is opened in order to trigger a flow of fluid from the reservoir to the pressure chamber, avoiding the primary gasket from preventing such a fluid passage, thus increasing the pressure in the pressure chamber.

In order to fulfill this function, the primary gasket is a three-lip gasket comprising an inner lip, a central lip, and an outer lip which project from the back portion to be radially and mutually spaced apart. The inner lip is configured to form a seal with the float. The outer lip is configured to form a seal with an outer wall of the primary housing when the pressure in the pressure chamber is higher than the pressure in the reservoir, thus fluidically isolating the pressure chamber and the reservoir. The outer lip is configured to bend toward the central lip moving away from the outer wall of the housing when the pressure in the reservoir is higher than the pressure in the pressure chamber, thus allowing a fluid communication between the reservoir and the pressure chamber. When the reservoir pressure exceeds the pressure chamber pressure, the primary gasket is configured to slide axially in the primary housing from the fluid isolation configuration to a fluid communication configuration, thus axially abutting with the central lip against a second radial wall of primary housing axially opposite to said first radial wall. Moreover, the central lip is configured to bend toward the inner lip, allowing the reservoir and the pressure chamber to be fluidically connected, thus allowing the pressure in the pressure chamber to be increased.

Once the at least one valve is closed, the primary gasket is configured to slide axially to the fluid isolation configuration, abutting with the back portion against the first radial wall until it fluidically isolates the reservoir and the pressure chamber.

It has been found in the industry that when the primary gasket is overstressed in the fluid communication configuration, the outer lip and the central lip can bend excessively leading to the rotation of the primary gasket in the primary housing, which can compromise the return of the primary gasket to the fluid isolation configuration, thus jeopardizing the proper operation of the cylinder assembly.

Therefore, the need to stabilize the primary gasket when working in the fluid communication configuration is strongly felt in the industry, reducing the risk of unintended rotations of the primary gasket which can obstruct the passage of fluid from the reservoir to the pressure chamber and/or vice versa.

Therefore, the need to obstruct the passage of fluid through the primary gasket as little as possible is strongly felt in the industry, avoiding as much as possible a bending of the central lip which could lead to rotation of the primary gasket.

### Solution

It is the object of the present invention to provide a primary gasket for a cylinder assembly which allows solving the complained problems of the prior art.

This and other objects and advantages are achieved by a primary gasket according to claim 1 and cylinder assembly according to claim 9.

Some advantageous embodiments are the subject of the dependent claims.

By virtue of the suggested solutions, a high fluid passage can be ensured through the central lip, reducing the resistance to fluid passage compared to the prior art.

By virtue of the suggested solutions, a high fluid passage can be ensured, reducing the tendency of the central lip to bend, or even avoiding a bending of the central lip.

By virtue of the suggested solutions, a seamless abutment of the central lip against the radial wall of the primary gasket housing can be ensured, while simultaneously ensuring low resistance to the passage of fluid on the one hand, and high bending resistance or structural strength of the central lip on the other hand, keeping the central lip stably abutting.

### FIGURES

Further features and advantages of the primary gasket and the cylinder assembly will become apparent from the following description of preferred embodiments thereof, given by way of non-limiting indication, with reference to the accompanying drawings, in which:

FIG. 1 is an axonometric view of a primary gasket according to the present invention showing an annular gasket body having an inner lip, an outer lip, and a central lip projecting in an axial direction from a gasket back portion, where the central lip comprises a central lip edge, and at least one radial opening through the thickness of the central lip avoiding interference with the central lip edge;

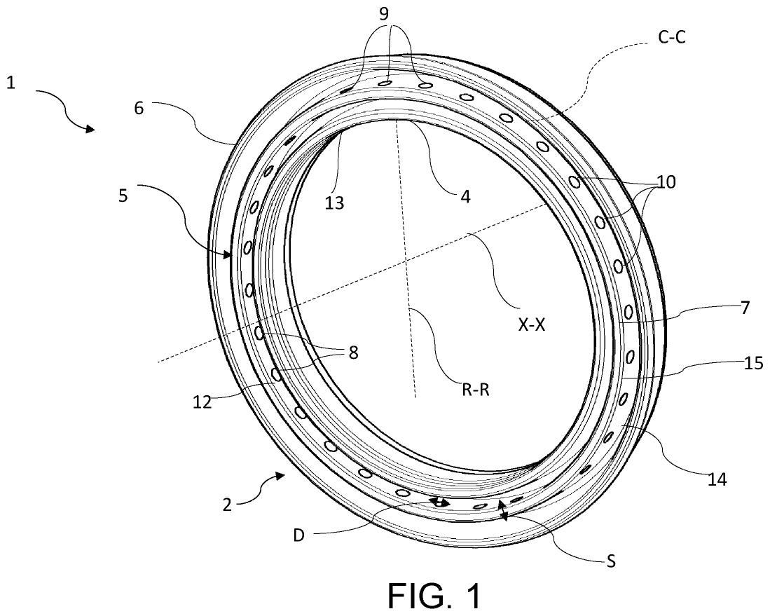

FIG. 2 is an axonometric view of the primary gasket in FIG. 1 seen from an opposite direction, showing the back portion of the primary gasket;

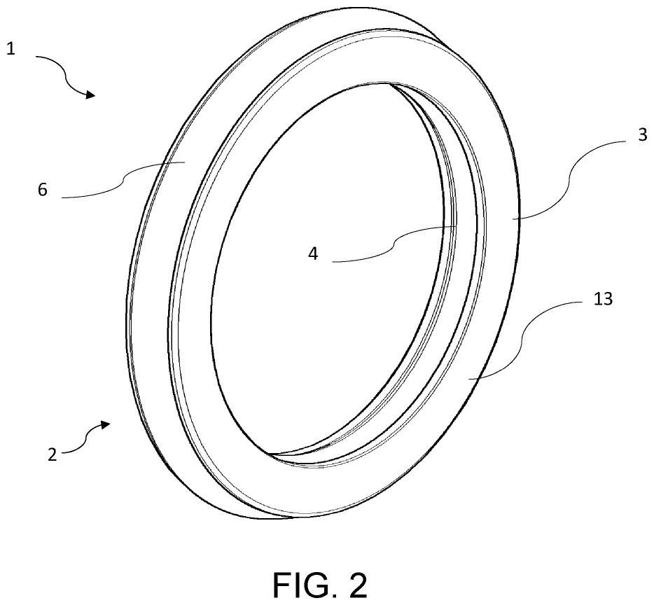

FIG. 3 shows a front view of the primary gasket in FIG. 1;

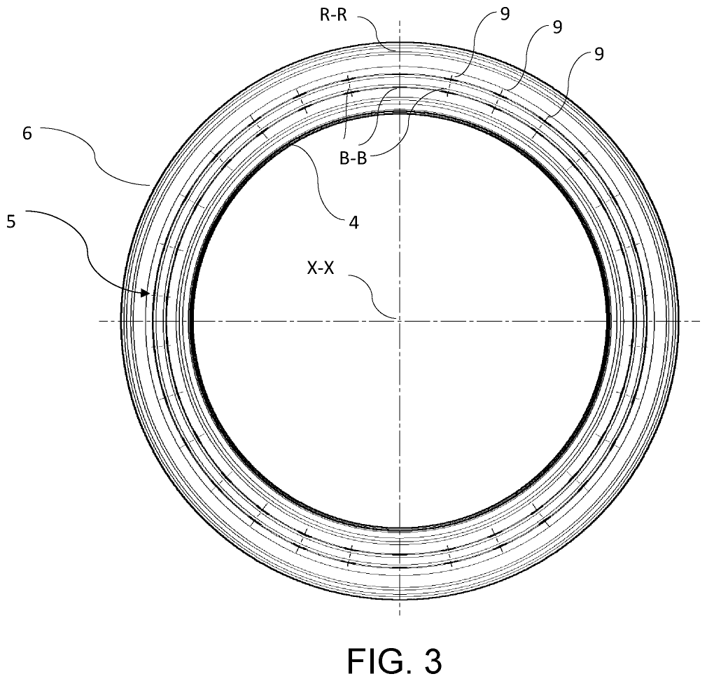

FIG. 4 shows the gasket in FIG. 1 sectioned along a parallel plane and comprising the radial direction R-R in FIG. 3, in which the central lip is sectioned at the radial opening axis;

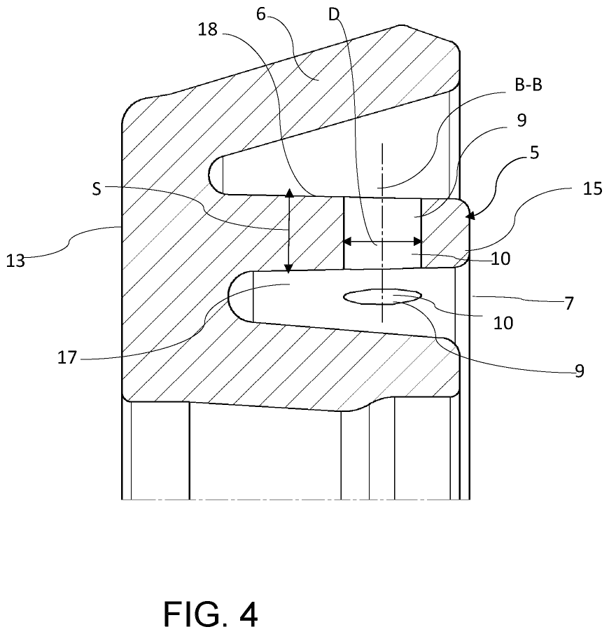

FIG. 5 is an axonometric view of a cylinder assembly according to the present invention, e.g., a brake master cylinder actuatable by a lever to pressurize a fluid, or an actuator for BBW (Brake By Wire) systems governed by an electric motor to pressurize a brake fluid;

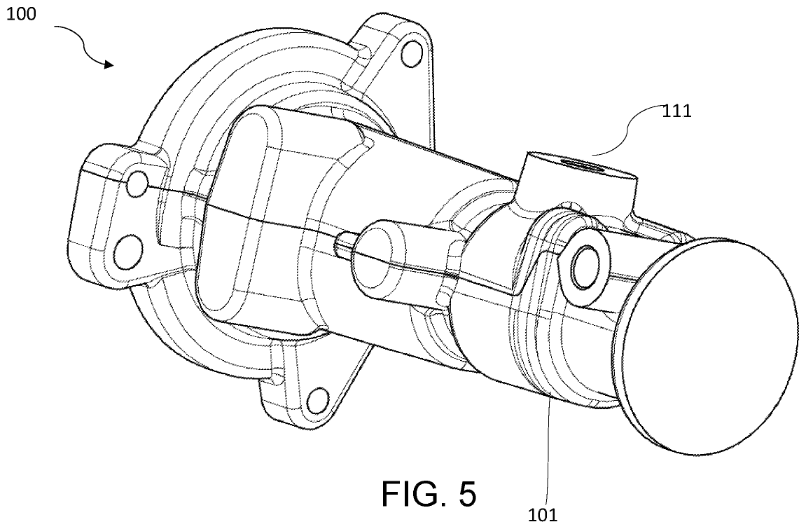

FIG. 6 is a section view of the cylinder assembly in FIG. 5 sectioned along a section plane perpendicular to the axial direction X-X and the radial direction R-R, showing the float or piston slidingly accommodated in the float housing made in the sealed cylinder by virtue of the primary gasket in FIG. 1 and a secondary gasket.

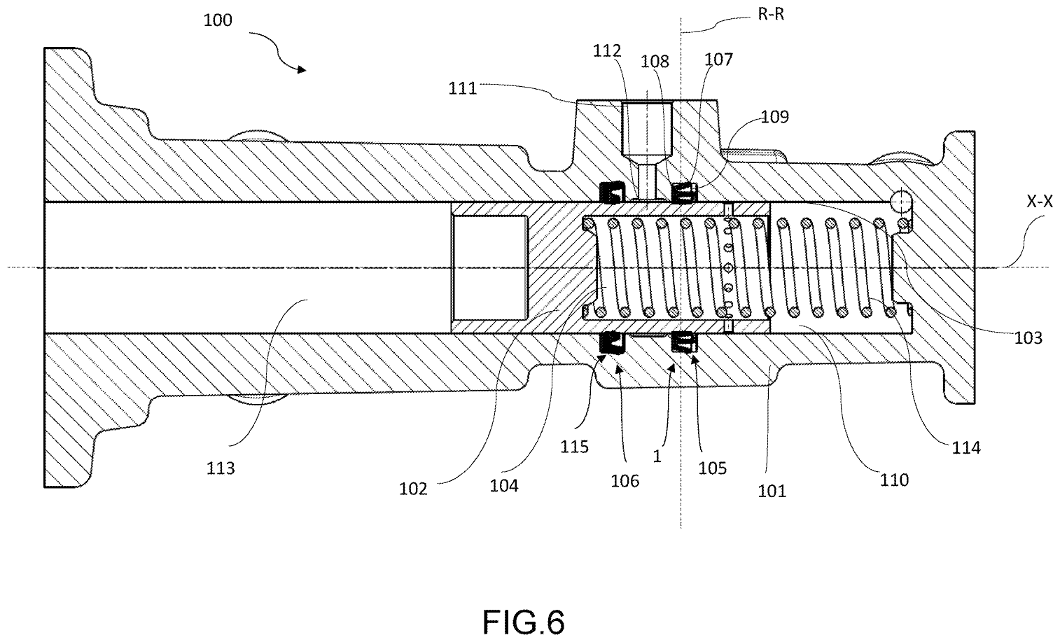

### DESCRIPTION OF SOME PREFERRED EMBODIMENTS

According to a general embodiment, a primary gasket for a cylinder assembly is indicated by reference numeral 1. Said cylinder assembly 100 comprises a cylinder 101 and a float 102 slidingly accommodated in a float housing 104 delimited by a cylinder wall 103 of said cylinder 101 for pressurizing a fluid. For example, said cylinder assembly 100 is a brake master cylinder or an electro-hydraulic actuator. According to an embodiment, said electro-hydraulic actuator is a linear actuator.

The primary gasket 1 comprises an annular body 2, which extends circumferentially at least along a circumferential direction C-C about an axial direction X-X, where said primary gasket 1 defines a radial direction R-R perpendicular to said axial direction X-X and said circumferential direction C-C.

Said annular body 2 is configured to be accommodated in a primary gasket housing 105 defined in said cylinder wall 103. The primary gasket housing 105 is delimited radially by an axial housing wall 107 and axially by a first radial housing wall 108 and a second radial housing wall 109, connected to said axial housing wall 107, forming an annular housing.

Said annular body 2 comprises an inner lip 4, a central lip 5, an outer lip 6, and a back portion 3.

The back portion 3 comprises a back abutment surface 13 configured to abut against the first radial housing wall 108 of said primary gasket housing 105.

The inner lip 4, the central lip 5, and the outer lip 6 extend from the back portion 3 in the axial direction X-X spaced from one another in the radial direction R-R from the opposite side of the back abutment surface 13.

The inner lip 4 is configured to form a preferably dynamic and static seal on the float 102.

The outer lip 6 is configured to form a seal with said axial housing wall 107.

The central lip 5 comprises an annular lip body 14, which extends axially between said back portion 3 and a central lip edge 15.

The annular lip body 14 has a central lip thickness S along said radial direction R-R.

The central lip edge 15 comprises at least one central lip abutment portion 7 configured to abut against the second radial wall 109.

Advantageously, the central lip 5 comprises at least one radial opening 9. Said at least one radial opening 9 passes through the central lip thickness S defining a closed side opening profile 8 in said annular body 14.

Due to the provision of the at least one radial opening 9 passing through the central lip thickness S, at least one fluid passage in the central lip 3 laterally delimited by the annular lip body 14 can be defined, which allows fluid passages even when the central lip is fully abutting with the central lip edge 15 thereof against the second radial housing wall.

According to an embodiment, said central lip 5 comprises at least one side opening wall 10, where said at least one side opening wall 10 seamlessly delimits said at least one radial opening 9.

According to an embodiment, said central lip 5 comprises a radially inner axial surface 17 and a radially outer axial surface 18, facing said inner lip 4 and said outer lip 6, respectively.

According to an embodiment, each side opening wall 10 extends mainly radially from said radially inner axial surface 17 to said radially outer axial surface 18 avoiding the interference with said central lip edge 15 and defining said closed side opening profile 8.

According to an embodiment, each radial opening 9 has a respective opening axis B-B, where each opening 9 is delimited seamlessly about the respective opening axis B-B by a respective opening side wall 10 of said annular lip body 14.

According to an embodiment, each radial opening 9 has a respective opening diameter D.

According to an embodiment, said closed side opening profile 8 is cylindrical or prismatic in shape.

According to an embodiment, said closed side opening profile 8 is defined by a side opening wall 10 of said annular lip body 14, which extends at least radially from said central lip thickness S, where said respective side opening wall 10 has a cylindrical extension about said opening axis B-B or comprises a plurality of side walls laterally delimiting a hollow prism.

According to an embodiment, said opening diameter D is at least equal to said central lip thickness S.

According to an embodiment, each opening axis B-B is axially spaced apart from said central lip edge 15 by a distance less than twice the value of said opening diameter D.

According to an embodiment, each opening axis B-B is axially spaced apart from said back abutment surface 13 by a distance equal to at least three times the value of said opening diameter D, preferably between four times and six times the value of said opening diameter D.

Due to the provision of the at least one radial opening 9 and/or each radial opening close to said central lip edge 15 and/or said central lip abutment portion 7, a fluid passage through the third lip can be allowed while avoiding the third lip from bending.

According to an embodiment, the central lip 5 comprises a plurality of said at least one radial opening 9, where said radial openings 9 are circumferentially spaced apart from one another on said central lip 5.

According to an embodiment, each radial opening 9 is circumferentially spaced apart from one neighboring first radial opening of said radial openings 9 by a distance equal to at least the value of said diameter D, preferably equal to at least three times the value of said diameter D. According to an embodiment, the distance between two neighboring first openings is understood as the distance between the respective opening axes B-B.

According to an embodiment, said radial openings 9 are evenly distributed circumferentially over said annular lip body 14.

According to an embodiment, the number of said radial openings 9 is between 10 and 100, preferably between 20 and 50, preferably 30.

According to an embodiment, said at least one central lip abutment portion 7 configured to abut against the second radial wall 109 extends seamlessly along the central lip edge 15 forming a continuous annular abutment portion.

Due to the provision of a continuous abutment portion of the third lip, a uniform and stable abutment can be ensured, and by providing radial openings passing through the thickness of the third lip and arranged close to the central lip edge 15, the axial surface area of the central lip facing the fluid can be reduced, avoiding the central lip 5 from bending.

According to an embodiment, said central lip edge 15 is an annular edge, avoiding comprising flat surfaces perpendicular to the axial direction. According to an embodiment, the central lip is tapered in the axial direction, e.g., close to the central lip edge 15.

According to an embodiment, the inner lip 4 and the outer lip 6 have substantially the same axial size in the axial direction X-X, where the central lip 5 has a greater axial size in the axial direction X-X than the axial size of the outer lip and the inner lip, being less than the central lip thickness S.

According to an embodiment, said annular body 2 is made of polymer material for gaskets, e.g., gasket rubber, preferably EPDM (Ethylene-Propylene Diene Monomer).

The present invention also relates to a cylinder assembly 100 for a braking system.

Said cylinder assembly 100 comprises a cylinder 101. Said cylinder 101 comprises a cylinder wall 103 internally delimiting a float housing 104. Said cylinder wall 103 delimits a pressure chamber fluidically connectable to a braking device. Said cylinder wall 103 delimits a primary gasket housing 105 and a secondary gasket housing 106. Said cylinder 101 defines a supply conduit 111 fluidically connectable to a reservoir and/or a fluid feeding valve, where said supply conduit 111 leads into a supply opening 112 on said cylinder wall 103 between said primary gasket housing 105 and said secondary gasket housing 106.

Said cylinder assembly 100 comprises a float 102. The float 102 is slidingly accommodated in a sealing manner in the float housing 104 to pressurize a fluid in a chamber 110 fluidically connectable to a braking device.

Said cylinder assembly 100 comprises a primary gasket 1 according to any one of the previously described embodiments. The primary gasket 1 is accommodated in said primary gasket housing 105 with axial clearance between said first radial housing wall 108 and second said radial housing wall 109. When the primary gasket 1 abuts against said first radial housing wall 108, it forms a seal with said float 102 and said axial wall 107 of primary housing thus fluidically isolating the pressure chamber and the supply conduit 111. When the primary gasket 1 abuts against said second radial housing wall 109, it forms a seal with said float 102 avoiding the formation of a seal with the axial wall 107 of the primary housing to fluidically connect the supply conduit 111 and the pressure chamber 110 to increase the fluid pressure.

Said cylinder assembly 100 comprises a secondary gasket 115 accommodated in the secondary gasket housing 106 to form a static and dynamic seal with said float and said cylinder wall 103.

According to an embodiment, said secondary gasket 115 is a two-lip gasket.

According to an embodiment, said cylinder assembly 100 is a brake master cylinder.

According to an embodiment, said cylinder assembly 100 is an electro-hydraulic actuator. According to an embodiment, said electro-hydraulic actuator is an actuator for BBW (Brake By Wire) applications.

According to an embodiment, said cylinder assembly 100 comprises an actuator motor 113.

According to an embodiment, said cylinder assembly 100 comprises an elastic element 114 accommodated inside said cylinder 101, which constantly biases said float 102 in the opposite direction to a float advancement direction.

According to an embodiment, the float 102 is axially movable between a resting configuration and at least one advanced configuration to pressurize a fluid, such as a brake fluid, in the pressure chamber.

According to an embodiment, the primary gasket 1 is axially movable in the primary gasket housing between a fluid isolation configuration, in which the back portion 3 abuts against the first radial housing wall and the outer lip forms a seal with the axial wall and the inner lip forms a seal with the float 102, and a fluid communication configuration, in which the protuberances 10, 9 abut against the second radial housing wall and the outer lip is spaced apart from the axial wall and the inner lip forms a seal with the float 102.

According to an embodiment, the float comprises a float body having a hollow portion delimited by a float wall, where the hollow portion is in fluid connection with the pressure chamber, where the float wall has a through opening. As long as said through opening is arranged between the primary gasket and the secondary gasket, the pressure chamber is in fluid communication with said supply conduit through said through opening. When said float is in said advanced configuration in which said through opening is axially advanced with respect to the primary gasket, the pressure chamber is fluidically isolated from the supply conduit by means of the primary gasket in the fluid isolation configuration, and the float pressurizes the fluid in the pressure chamber. When the fluid in the supply conduit exceeds the fluid pressure in the pressure chamber, the primary gasket switches to the fluid communication configuration, allowing the pressure in the pressure chamber to be increased.

### LIST OF REFERENCE SIGNS

1 primary gasket
2 annular body
3 back portion
4 inner lip
5 central lip
6 outer lip
7 central lip abutment portion
8 closed side opening profile
9 radial opening
10 opening side wall
13 back abutment surface
14 annular lip body
15 central lip edge
17 radially inner axial surface of central lip
18 radially outer axial surface of central lip
100 cylinder assembly
101 cylinder
102 float
103 cylinder wall
104 float housing
105 primary housing or primary gasket housing
106 secondary housing or secondary gasket housing
107 axial wall of primary housing
108 first radial wall of primary housing
109 second radial wall of primary housing
110 pressure chamber
111 supply conduit
112 supply opening
113 actuator motor
114 elastic element
115 secondary gasket
X-X axial direction
R-R radial direction
C-C circumferential direction
B-B radial opening axis
S central lip thickness
D radial opening diameter

1-10. (canceled)

11. A primary gasket (1) for a cylinder assembly (100), wherein said cylinder assembly (100) comprises a cylinder (101) and a float (102) slidingly housed in a float housing (104) delimited by a cylinder wall (103) of said cylinder (101) for pressurizing a fluid,
wherein the primary gasket (1) comprises an annular body (2), which extends circumferentially at least along a circumferential direction (C-C) about an axial direction (X-X), wherein said primary gasket (1) defines a radial direction (R-R) perpendicular to said axial direction (X-X) and said circumferential direction (C-C),
wherein said annular body (2) is configured to be accommodated in a primary gasket housing (105) defined in said cylinder wall (103), in which the primary gasket housing (105) is delimited radially by an axial housing wall (107) and axially by a first radial housing wall (108) and a second radial housing wall (109) connected to said axial housing wall (107),
wherein said annular body (2) comprises an inner lip (4), a central lip (5), an outer lip (6), and a back portion (3),
wherein the back portion (3) comprises a back abutment surface (13) configured to abut against the first radial housing wall (108) of said primary gasket housing (105),
wherein the inner lip (4), central lip (5), and outer lip (6) extend axially from the back portion (3), on the side opposite the back abutment surface (13), radially spaced apart from one another,
wherein the inner lip (4) is configured to form a seal with said float (102),
wherein the outer lip (6) is configured to form a seal with said axial housing wall (107),
wherein the central lip (5) comprises an annular lip body (14), which extends axially between said back portion (3) and a central lip edge (15), wherein the annular lip body (14) has a central lip thickness (S) along said radial direction (R-R), wherein the central lip edge (15) comprises at least one central lip abutment portion (7) configured to abut against the second radial wall (109),
wherein the central lip (5) comprises at least one radial opening (9),
wherein said at least radial opening (9) passes through the central lip thickness (S) defining a closed side opening profile (8) in said annular body (14).

12. A primary gasket (1) according to claim 11,
wherein said central lip (5) comprises at least one side opening wall (10), wherein said at least one side opening wall (10) seamlessly delimits said at least one radial opening (9),
wherein said central lip (5) comprises a radially inner axial surface (17) and a radially outer axial surface (18) respectively facing said inner lip (4) and said outer lip (6),
wherein each side opening wall (10) extends predominantly and radially from said radially inner axial surface (17) to said radially outer axial surface (18) avoiding interfering with said central lip edge (15) and defining said closed opening side profile (8).

13. A primary gasket (1) according to claim 11, comprising one or more of the following features or a combination thereof:
wherein each radial opening (9) has a respective opening axis (B-B), wherein each opening (9) is delimited about the respective opening axis (B-B) seamlessly by a respective opening side wall (10) of said annular lip body (14); and/or
wherein each radial opening (9) has a respective opening diameter (D); and/or
wherein said closed side opening profile (8) has either a cylindrical or a prismatic shape; and/or
wherein said closed side opening profile (8) is defined by a side opening wall (10) of said annular lip body (14), which extends at least radially of said central lip thickness (S), wherein said respective side opening wall (10) has a cylindrical extension about said opening axis (B-B) or comprises a plurality of side walls, which laterally delimit a hollow prism.

14. A primary gasket (1) according to claim 13, comprising one or more of the following features or a combination thereof:
wherein each opening axis (B-B) is axially distanced from said central lip edge (15) by a distance less than twice the value of said opening diameter (D), and/or
wherein each opening axis (B-B) is axially spaced from said back abutment surface (13) by a distance equal to at least three times the value of said opening diameter (D), preferably comprised between four times and six times the value of said opening diameter (D),
wherein said opening diameter (D) is at least equal to said central lip thickness (S).

15. A primary gasket (1) according to claim 11,
wherein the central lip (5) comprises a plurality of said at least one radial opening (9),
wherein said radial openings (9) are circumferentially spaced apart from each other on said central lip (5).

16. A primary gasket (1) according to claim 15,
wherein each radial opening (9) is circumferentially spaced from one of its radial openings close to said radial openings (9) by a distance equal to at least the value of said diameter (D), preferably equal to at least three times the value of said diameter (D).

17. A primary gasket (1) according to claim 16, comprising one or more of the following features or a combination thereof:
wherein said radial openings (9) are uniformly distributed circumferentially over said annular lip body (14), and/or
wherein there are from 10 to 100 of said radial openings (9), preferably from 20 to 50, preferably 30.

18. A primary gasket (1) according to claim 11, wherein said at least one central lip abutment portion (7) configured abut against the second radial wall (109) extends seamlessly along the central lip edge (15) forming a continuous annular abutment portion.

19. A cylinder assembly (100) for a braking system, comprising
a cylinder (101)
wherein said cylinder (101) comprises a cylinder wall (103), which internally delimits a floating housing (104),
wherein said cylinder wall (103) delimits a pressure chamber fluidically connectable to a braking device,
wherein said cylinder wall (103) delimits a primary gasket housing (105) and a secondary gasket housing (106), wherein the primary gasket housing (105) is radially delimited by an axial housing wall (107) and axially delimited by a first radial housing wall (108) and a second radial housing wall (109) connected to said axial housing wall (107),
wherein said cylinder (101) defines a supply conduit (111) fluidically connectable to a reservoir and/or fluid feeding valve, wherein said supply conduit (111) leads into a supply opening (112) on said cylinder wall (103) between said primary gasket housing (105) and said secondary gasket housing (106),
a float (102),
wherein the float (102) is slidingly accommodated in a sealing manner in the float housing (104) to pressurize the fluid in a pressure chamber (110) fluidically connectable to a braking device,
a primary gasket (1) according to any one of the preceding claims, wherein the primary gasket (1) is accommodated in said primary gasket housing (105) with an axial clearance between said first radial housing wall (108) and said second radial housing wall (109), wherein said primary gasket (1) when it abuts against said first radial housing wall (108) is configured to form a seal with said float (102), and said primary housing axial wall (107) fluidically isolating the pressure chamber and supply conduit (111), and wherein said primary gasket (1) when it abuts against said second radial wall (109) is configured to form a seal with said float (102) preventing the formation of a seal with the primary housing axial wall (107) abutting against said second radial housing wall (109) to fluidically connect the supply conduit (111) and the pressure chamber (110) to increase the fluid pressure in the pressure chamber,
a secondary gasket (115) accommodated in the secondary gasket housing (106) to form a static and dynamic seal with said floating (102) and said cylinder wall (103).

20. A cylinder assembly (100) according to claim 19 wherein said cylinder assembly (100) is a master cylinder or is an electrohydraulic actuator, preferably for BBW (Brake By Wire) applications.
